(19) United States
(12) Patent Application Publication
(10) Pub. No.: US 2023/0185870 A1
(43) Pub. Date: Jun. 15, 2023

(54) PREDICTION MODELING FOR DIFFERENCING TECHNIQUE

(71) Applicant: Business Objects Software Ltd., Dublin (IE)

(72) Inventor: Marc Bizeul, Puteaux (FR)

(21) Appl. No.: 17/547,204

(22) Filed: Dec. 9, 2021

(51) Int. Cl. G06F 17/11; G06Q 10/04

(52) U.S. Cl. CPC G06F 17/11; G06Q 10/04

(57) ABSTRACT

A system and method including determining, for a calculation of a predicted value specified by a recursive equation, an equivalent representation based on a cumulative sum; determining a trend component for the determined equivalent representation of the predicted value; decomposing the determined equivalent representation of the predicted value into the trend component and a cyclic component; and generating a visualization for a set of time series data expressed by the decomposition.

### BACKGROUND

Time series data contains sequential data points (e.g., data values) that are observed at successive time durations (e.g., hourly, daily, weekly, monthly, annually, etc.). For example, monthly sales, daily stock prices, annual profits, etc., are examples of time-series data. There are numerous types of prediction models. Time series forecasting may employ one or more processes to observe historical values of time series data and predict future values of the time series data. Time series forecasting results may be presented to a user in a visualization of the predicted future values.

In addition to accurately predicting future values, visualizations of a time series prediction determination should clearly convey the factors contributing to the predicted future values so that, for example, the visualizations can be efficiently interpreted and understood by observers thereof.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is an illustrative example visualization of time series data;

FIG. 2 is an illustrative example visualization of time series data based on a differencing technique;

FIG. 3 is an illustrative example visualization of time series data based on a differencing technique, including depictions of cyclic patterns;

FIG. 4 is an illustrative example visualization of predicted values for time series data based on a differencing technique;

FIG. 5 is an illustrative example visualization of predicted values for time series data based on a differencing technique, including model components that model variations of the time series;

FIG. 6 is an illustrative example visualization of predicted values for time series data based on a differencing technique, including model components that model variations of the time series;

FIG. 7 is an illustrative example visualization of predicted values for time series data based on a differencing technique, including model components that model the time series, in accordance with an example embodiment;

FIG. 8 is an illustrative example visualization of predicted values for time series data based on a differencing technique, including aspects of a time series decomposition, in accordance with an example embodiment;

FIG. 9 is an illustrative example visualization of predicted values for time series data based on a differencing technique, including aspects of a time series decomposition, in accordance with an example embodiment;

FIG. 10 is an illustrative listing of a predicted equation for time series data based on a differencing technique, including model components that model the time series, in accordance with an example embodiment;

FIG. 11 is an illustrative example visualization of predicted values for time series data based on a differencing technique, including a trend component and a cyclic component, in accordance with an example embodiment;

FIG. 12 is an illustrative example visualization of predicted values for time series data based on a differencing technique, including aspects of a trend component for the time series, in accordance with an example embodiment;

FIG. 13 is an illustrative flow diagram of a process, in accordance with an example embodiment;

FIG. 14 is an outward facing user interface related to a system and process for visualization of predicted values for time series data based on a differencing technique, in accordance with an example embodiment;

FIG. 15 is an outward facing user interface related to a system and process for visualization of predicted values for time series data based on a differencing technique, in accordance with an example embodiment; and

FIG. 16 is an illustrative block diagram of a system to generate and present data analytics visualizations of predicted values for time series data based on a differencing technique, in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and convenience.

### DETAILED DESCRIPTION

In the following description, specific details are set forth in order to provide a thorough understanding of the various example embodiments. It should be appreciated that various modifications to the embodiments will be readily apparent to those skilled in the art, and the one or more principles defined herein may be applied to other embodiments and applications without departing from the spirit and scope of the present disclosure. Moreover, in the following description, numerous details are set forth for the purpose of explanation. However, one of ordinary skill in the art should understand that embodiments may be practiced without the use of these specific details. In other instances, well-known structures, methods, procedures, components, and circuits are not shown or described so as not to obscure the description with unnecessary detail. Thus, the present disclosure is not intended to be limited to the embodiments shown but is to be accorded the widest scope consistent with the principles and features disclosed herein.

The present disclosure relates to time series prediction (i.e., forecasting or estimating of future outcome) processes that might be implemented by a variety of devices and systems configured to execute computing applications to effectuate the time series prediction processes disclosed herein. Embodiments of the disclosed time series predictions may be provided in an on premise environment, a cloud computing environment (e.g., Software as a service (SaaS), Platform as a service (PaaS), Infrastructure as a service (IaaS), etc.), and combinations thereof. For context, a prediction module or engine of a computing system might use several modeling techniques to generate a “best” possible prediction for a set of time series data. The system may further compare the predictions generated using each of the different modeling techniques and (automatically) determine the “best” prediction based on one or more quality of prediction objectives to generate predicted values for the input set of time series data.

In some aspects, a significant feature of time series predicting is an ease or clarity of explanation associated with a time series prediction process used to predict future values for a set of time series data. For example, in an effort to support user confidence in the predicted future values generated by a particular time series prediction process and system, an entity (e.g., system or service provider personnel, machine generated explanation, etc.) might explain or otherwise indicate how the predictive model used to generate the predicated values calculated or determined the predictive values. In some aspects, it is desirable to provide an explanation of the predicted future values generated by a time series prediction process and system that are easily and readily understood (i.e., intuitive). Some time series prediction processes might be easier to explain than others.

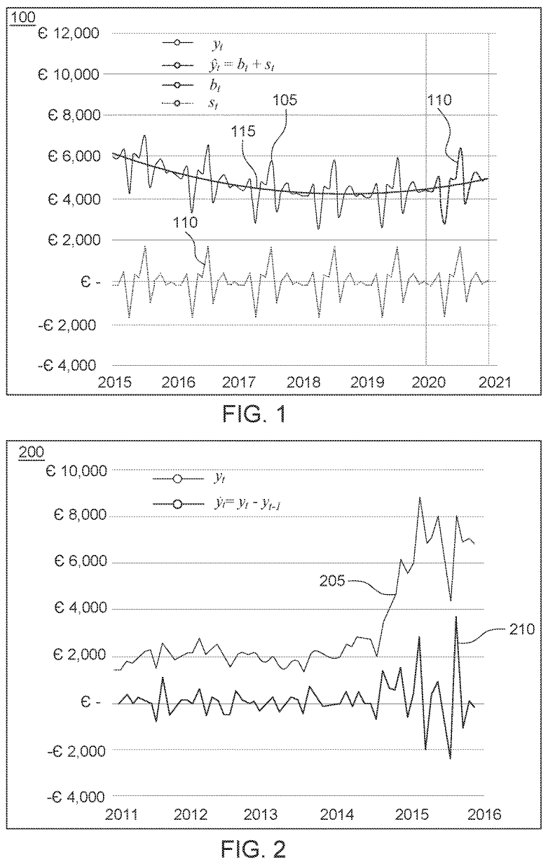

FIG. 1 is an illustrative example visualization of time series predicted data generated by a modeling engine that models the entire time series yₜ (105) by decomposing it into a trend component and one or more cyclic patterns or components sₜ. The modeling engine calculates the predicted data point by summing the evaluation of the detected model components at time t, as expressed by the following equation.

ŷₜ=bₜ+sₜ

where ŷₜ represents a predicted data point, bₜ represents a trend (the trend is quadratic in the current example), and sₜ represents a cycle (the cycle has a length of one year in the present example). In the present example, the modeling engine detected two components. The number of contributing components to a predicted value is not necessarily limited to two components herein, unless stated otherwise.

Referring to FIG. 1, the time series data 105 (solid line) is presented in visualization 100 in combination with its associated trend component bₜ (115) and cyclic component sₜ (120). Each cycle in FIG. 1 spans a year, but the recurrence length can be different depending on the time series data. Viewing visualization 100, it is clear that the trend component bₜ (115) and cyclic component sₜ (120) cumulatively contribute to the predicted (i.e., calculated future or forecast) data 110 (dashed line). For example, the predicted data 110 has a similar shape as the cyclic data and tracks the calculated trend.

FIG. 1 is an example of, as used herein, a time series decomposition where the prediction equation results from the sum of the model components. Visualization 100 depicts the original time series 105 of actual values in the past and its components bₜ and sₜ in a manner that an observer thereof can readily understand the prediction of future values 110 (dashed line) by “visually” summing the time series components. In some aspects, visualization 100 including the trend component bₜ and the cyclic component sₜ may be used in determinations of user and system actions. For example, if the time series data represents sales for an organization that are trending upward, the organization might take actions to adjust pricing, production, etc. based on the recurring cycles (e.g., the next two months correspond to recurring sharp seasonal increase) in terms of sales.

In some instances, a modeling engine or process might not be able to model a trend that accurately corresponds with the entire time series. This might typically be the case when the time series is disrupted. In some such instances, a modeling engine might use a modeling technique that models the variations in the time series, as opposed to modeling the values of the time series. That is, the modeling engine models the differences between two (2) observations as represented below.

\dot{y}ₜ=yₜ−yₜ₋₁ (1)

where \dot{y}ₜ represents the variations of the time series at time t, yᵣ represents a data point at time t, and yₜ₋₁ represents a data point at time previous time (t−1).

FIG. 2 is an illustrative example visualization 200 of time series data based on a differencing technique. FIG. 2 illustrates an example of first-order differencing. Visualization 200 depicts an original time series that is disruptive as line 205 and the variations of the time series at 210 corresponding to the variations of the time series 205 may be generated by a modeling engine in some aspects. Data series 210 is an illustrative representation of equation (1) corresponding to time series 205.

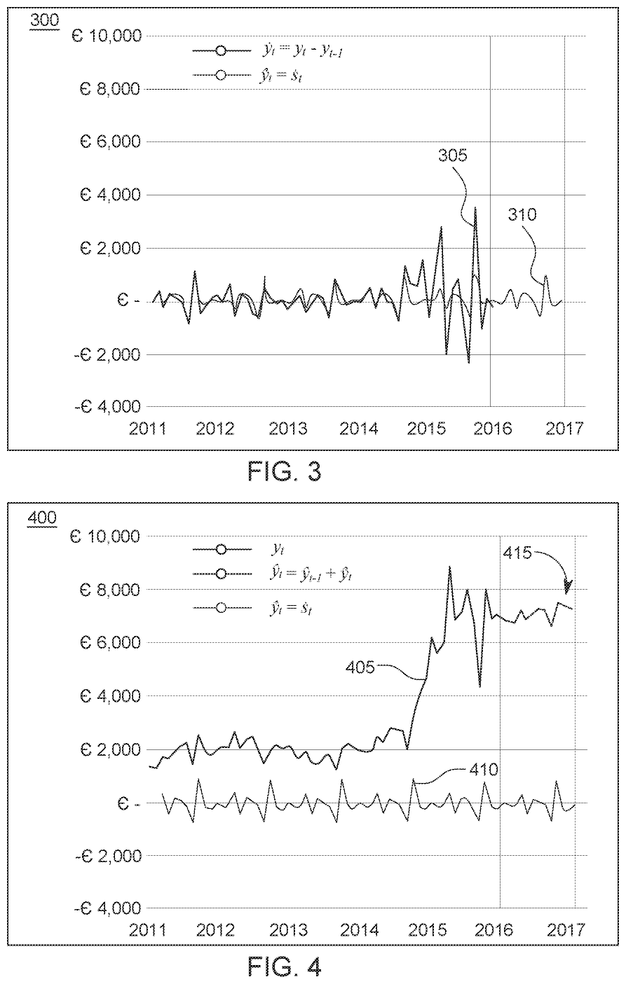

Regarding a time series decomposition of the variations of the time series \dot{y}ₜ, a modeling engine may model the cyclic patterns, \dot{s}ₜ, detected in the variations of the time series \dot{y}ₜ. FIG. 3 is an illustrative example visualization of time series data based on a differencing technique, including depictions of cyclic patterns. In the example of FIG. 3, the modeling engine detected a yearly cycle \dot{s}ₜ in the variations of the time series (though the length of the recurrences may vary depending on the data topology). Visualization 300 depicts the variations of the time series as plot line 305 and the cyclic patterns detected in the variations of the time series as plot line 310.

To generate a prediction for the differencing technique as illustrated by the time series example in FIG. 2, a modeling engine may calculate a predicted data point ŷₜ based on the previous predicted data point ŷₜ₋₁ to which the predicted variation of the time series \dot{ŷ}ₜ is added. Calculation of the predicted data point may be represented by the following expression.

ŷₜ=ŷₜ₋₁+\dot{ŷ}ₜ

Referring to FIG. 4, visualization 400 depicts the time series yₜ as solid line 405, the predicted variation of the time series \dot{ŷ}ₜ (i.e., equal to the cyclic patterns detected in the variations of the time series) as plot line 410, and the predicted data points as the dashed plot line in region 415. Viewing FIG. 4, it is not easily seen from visualization 400 how the predicted values at 415 results from the time series yₜ (line 405) and the predicted variation of the time series \dot{ŷ}ₜ (line 410).

As discussed regarding the example of FIG. 1, a (regular) time series decomposition technique wherein the prediction equation results from the sum of the model components may be easily seen and understood from the visualization 100. Again, visualization 100 shows the original time series 105 and its associated trend component bₜ and cyclic component sₜ, which an observer might easily understand by “visually” summing the illustrated time series components.

However, explaining or describing the predictive time series data for the differencing technique (e.g., the example of FIG. 4) might not be readily or easily understood by observing visualization 400 that includes depictions of the time series yₜ (solid line 405), the predicted variation of the time series \dot{ŷ}ₜ (plot line 410), and the predicted data points (dashed plot line in region 415).

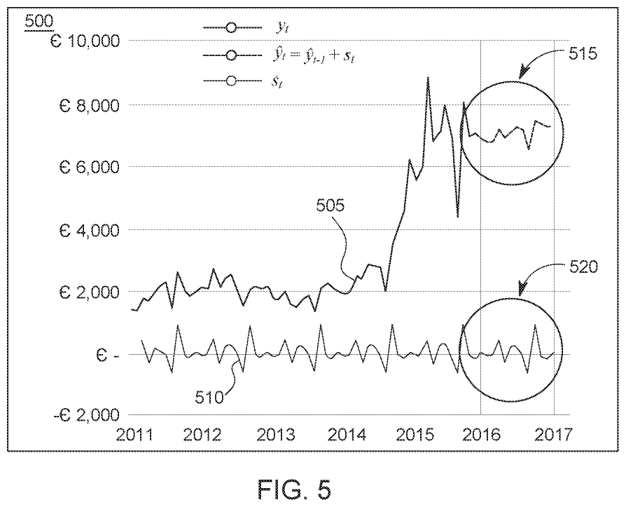

FIG. 5 is an illustrative example visualization of predicted values for time series data based on a differencing technique, including model components that model variations of the time series. In many respects, visualization 500 in FIG. 5 is similar to visualization 400 in FIG. 4. As illustrated in FIG. 5, a visualization including the original time series 505 and the components that model the variations of the time series, \dot{s}ₜ, 510 does not convey a visually intuitive explanation since the prediction equation is a recursive equation (e.g., ŷₜ=ŷₜ₋₁+\dot{s}ₜ), as depicted at region 515. Since the model components do not model the original time series and instead model the variations in the time series, the shape of the variations of the time series cycles (e.g., at region 520) do not match (e.g., shape or curvature) the prediction. Accordingly, it may be difficult to understand, have confidence in, and explain the generated prediction of visualization 500. This aspect is highlighted in FIG. 5 where only one model component is considered.

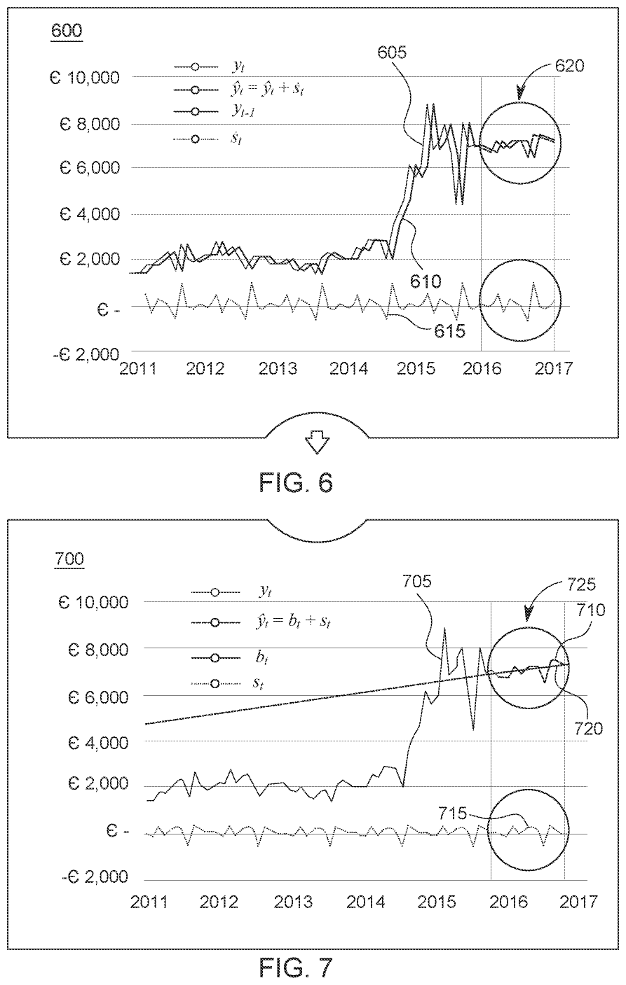

FIG. 6 is an illustrative example visualization of predicted values for time series data based on a differencing technique, including model components that model variations of a time series. Visualization 600 includes depictions of a disruptive the time series yₜ (solid line 605), a plot of the lag of the time series yₜ₋₁ (solid line 610), cyclic patterns \dot{s}ₜ that model variations of the time series (plot line 615), and the predicted data points (dashed plot line in region 620). Notably, the time series data 605 and the variations in the time series are in different value spaces. The time series 605 and the predicted data points in region 620 are in the same values space as the time series. The modeled variations of the time series 615 is in the value space of the variation of the time series, which is a different value space than the value space of the time series. Displaying these two different value spaces in the same visualization 600 might be misleading to an observer thereof or might result in a misinterpretation of what is being illustrated in the visualization.

In some aspects, a solution disclosed by the present disclosure includes, in some embodiments, representing a recursive equation for a prediction as an equivalent equation or expression that highlights, for example, a trend and a cyclic pattern that model the original time series instead of component(s) that model a variation of the time series. In some embodiments, the components specified in the equivalent equation or expression (e.g., a trend and a cyclic pattern) are in the same value space as the original time series.

By rewriting the recurring prediction equation, a desired result is to obtain an expression that is additive. In some embodiments, the resulting expression might be similar, in some aspects, to the regular signal decomposition technique (e.g., FIG. 1) for a given data point wherein a trend component and a corresponding cycle component may be added to obtain the predicted data point.

FIG. 7 is an illustrative example visualization 700 including predicted values for time series data based on a differencing technique and model components that model the time series, in accordance with an example embodiment. Visualization 700 includes a plot of the original disruptive time series 705, the trend component bₜ that model the time series, the cyclic component sₜ that model the time series, and the predicted data 710 in region 725. As illustrated by the example of FIG. 7, visualization 700 is easily understood (i.e., interpreted) to convey the predicted data points 710 in region 725 are the additive result of the trend component and the cyclic component of the time series.

Still referring to FIG. 7, trend bₜ (solid line 720 in region 725) represents the general trend starting from the first predicted data point. Regarding the cyclic component sₜ, the recurring cyclic pattern repeats (which depends on the topology of the data, but in this example the cycle recurs every year). The trend is a predicted data. In the example of FIG. 7, the trend is slightly increasing over time and there is a recurring pattern that repeats every year. So, each predicted data point 710 shown at region 725 results from the addition of the corresponding data points in the trend 720 and the corresponding data point in the cyclic data series 715 in the cycles that are series.

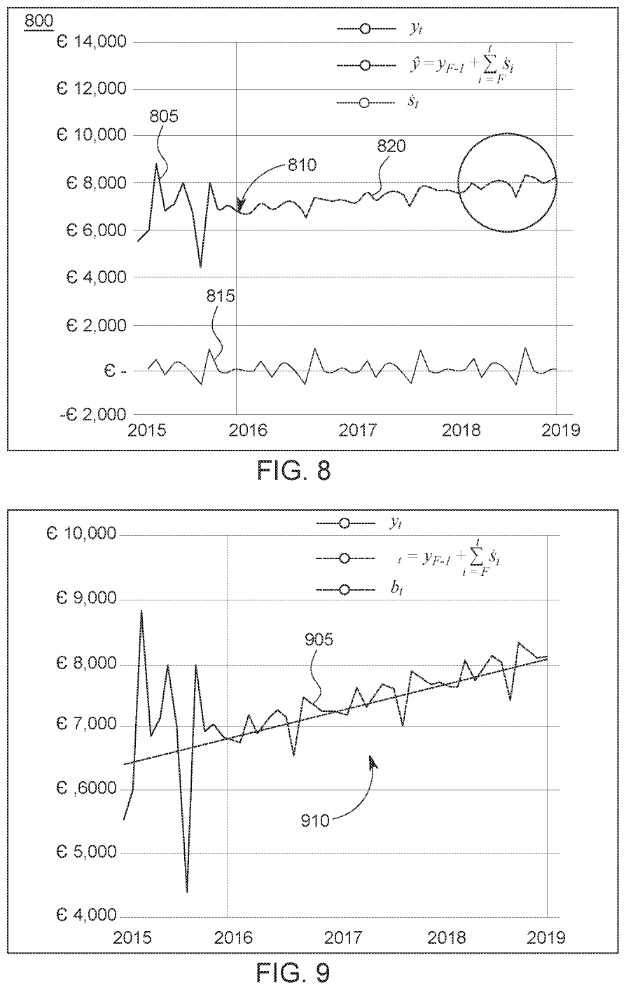

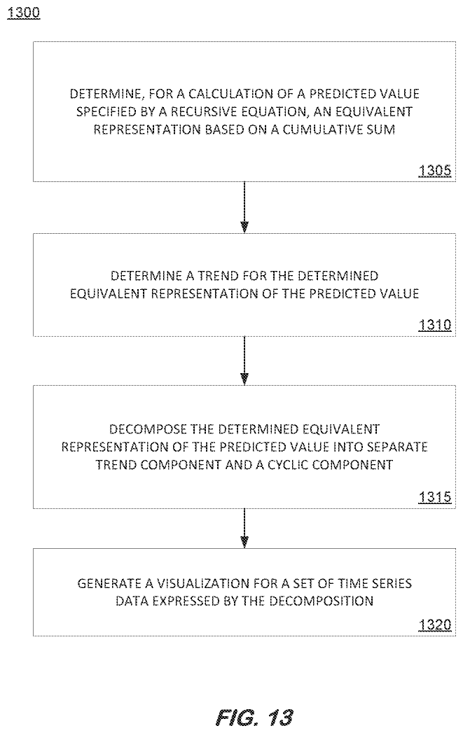

FIGS. 8-12 relate, in various aspects, to a process of a novel time series decomposition, in accordance with an example embodiment. The time series decomposition is summarized in a flow diagram of FIG. 13.

In an initial step (or a series of steps, executions, operations, etc.) the calculation of a predicted value at time t may be specified with a recursive equation, as follows.

ŷₜ=ŷₜ₋₁+\dot{s}ₜ (2)

As discussed above (e.g., discussion of 5), the predicted value at time t is equal to the sum of the previous predicted value and the component sₜ that models the variations of the time series.

The recursivity of equation (2) can be broken by rewriting an equivalent equation or expression that uses a cumulative sum from the first predicted data point, F. This equivalent expression is as follows.

ŷₜ=y_{F-1}+Σ_{i=F}^{t}\dot{s}ᵢ where t≥F (3)

Equations 2 and 3 are exact equivalents of each other. In equation 3, a sum of the variations from the first predicted data point (F) are used in the calculation of the predicted data point.

As an example, equation 3 can be used to calculate the first predicted data point (F), the first predicted data point that will be equal to the last actual data point (y_{F-1}) plus the predicted variation of the time series for the first predicted data point is (\dot{s}_{F}). This first data point is shown in visualization 800 of FIG. 8 at 810. Visualization 800 further depicts the actual time series data yₜ as solid line 805, the predicted variation of the time series \dot{s}ₜ as line 815, and the predicted value as dashed line 820.

Equation 3 yields a result equivalent to the recursive equation 2, except equation 3 is based on a cumulative sum. For example, the second predicted data point will be equal to the last actual data point (y_{F-1}) plus the first predicted variation and the second predicted variation; the third predicted data point will equal the last actual data point (y_{F-1}) plus the first predicted variation, the second predicted variation plus the third predicted variation; etc.

A next step focuses on the predicted data portion of the data visualization, as detailed in FIG. 9 by dashed line 905. With reference to FIG. 9, it is noted that considering any cyclic pattern \dot{s}ₜ detected in the variations for the time series has a constant amplitude over time, its cumulated form follows a linear slope m represented by the following equation.

$$m = \frac{1}{L} \cdot {\sum }_{i = 1}^{L} {\dot{s}}_{i} \qquad ( 4 )$$

where L is the length of an occurrence of cycle \dot{s}ₜ. The slope m can be constant, increasing, or decreasing, depending on whether the average variation of the time series is null, strictly positive, or strictly negative, respectively, over an occurrence of cycle \dot{s}ₜ.

Eq. 4 includes the variation of the time series and it is used to calculate the slope (m) of the trend. Stated another way, equation (4) is the formula that corresponds to the slope of the trend and in some aspects is an average. That is, if the average of all of the data points of an occurrence of cycle variation of time series is positive, then there is an increasing trend in the prediction; if the average is negative, then there is a decreasing trend; and if the average is null, then the trend is constant.

Thus, the trend of the forecast, bₜ, can be formalized as follows.

bₜ=y_{F-1}(t−F+1)·m (5)

where F is the first predicted data point, L is the length of an occurrence of cycle \dot{s}ₜ, and m is the slope of the trend (as specified by equation 4). As seen, equation 5 of the trend starts with a baseline (i.e., the last actual data point (y_{F-1})) and m is multiplied by where you are in the predicted region 910.

Since the cyclic variation is regular over time (i.e., it is always the same pattern that repeats of the time), it is necessarily a linear trend.

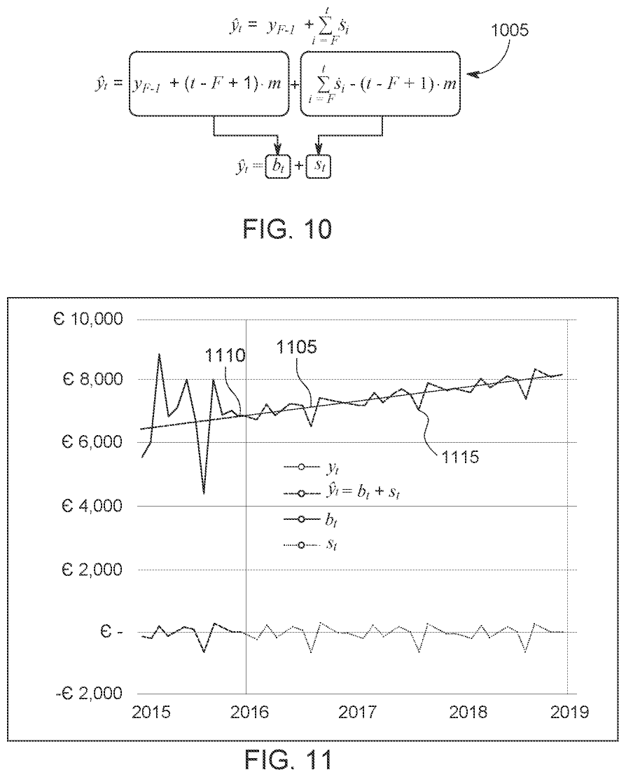

Based on the foregoing, the prediction equation (e.g., equation 3) to calculate a predicted value at t, which breaks to recursivity in eq. (2), can be rewritten to separate the trend component, bₜ, from the cyclic component sₜ, as outlined in FIG. 10. As shown at 1005 in FIG. 10, the trend is added and removed to maintain the value of the equation (i.e., an equivalent formula) to separate the expression into a trend component and a cyclic component. The result is an expression of the predicted value as two separate components, one that corresponds to the trend (bₜ) and one that corresponds to the cycle (sₜ).

As a result of the calculations illustrated in FIG. 10 at 1005, the trend representation and the cyclic representation are now in the same value space as the values of the original time series. Notably, the predicted value is not in the value space of the variation of the time series, as previously expressed.

Referring to FIG. 11, it is noted that the trend component bₜ (1105) is composed of a baseline (where F is the first predicted data point 1110) and a slope extracted from the cumulative sum of the cycles, as previously specified by equation 5. It is noted that equation 5 can be rewritten to highlight a polynomial of degree 1, that corresponds to a linear trend, as follows.

$${b}_{t} = {α}_{1} \cdot t + {α}_{0} where \{ \begin{matrix}{α}_{0} = {y}_{F - 1} - ( F - 1 ) \cdot m \\ {α}_{1} = m\end{matrix} \qquad ( 6 )$$

Accordingly, we have demonstrated a process to separate the trend component and the cycle component from the predicted data series 1115. The predicted data series obtained in this manner might be exposed to the user via a visualization in terms that a user can readily comprehend and understand.

Regarding the cyclic component sₜ, it is based on the cumulative sum of the cycles \dot{s}ᵢ from which the slope was extracted and can be expressed as follows.

sₜ=Σ_{i=F}^{t}\dot{s}ᵢ−(t−F+1)·m where t≥F (7)

It is noted that in some embodiments formula 7 only applies to the predicted horizon from the first data point F. However, in some embodiments it might be generalized to apply to the entire data series, as represented below.

sₜ=Σᵢ₌₀^{p}\dot{s}_{F+i}−(p+1)·m where p=(t−F)modulo L (8)

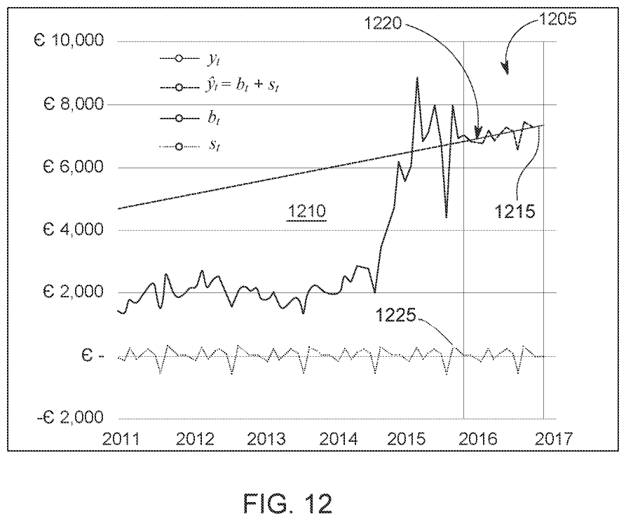

Referring to FIG. 12, the recurring pattern sₜ 1225 in the predicted region 1205 is exactly the same in the region 1210 corresponding to the actual time series data. As such, the same value space is used for the recurring pattern as the time series values. Notably, the recurring pattern is exactly the same cycle as in the past. Accordingly, equation 7 can be rewritten for t being from the first predicted data points as also being applicable to the past (i.e., the actual time series data), as represented in equation 8. In some aspects, this is applicable where a modeling engine also detects the same cycles in the past.

Note that in some embodiments the trend 1215 is valid for the predicted data region since there is a baseline for the trend. In some embodiments, the baseline for the predicted data will be from the first predicted data point 1220. Stated another way, the trend is determined for the predicted data.

As demonstrated above, the original component \dot{s}ₜ that models the variations of the time series is converted into components bₜ and sₜ that model the values of the time series. The trend component, bₜ, applies to the predicted data and the slope of bₜ applies over the entire time series.

FIG. 13 is an illustrative flow diagram of a process for determining a visualization of predicted values for time series data, in accordance with an example embodiment. Process 1300 demonstrates, at least in part, how aspects and features for determining and expressing predicted values for time series data herein might operate. At operation 1305, an equivalent representation based on a cumulative sum is determined for a calculation of a predicted value specified by a recursive equation. For example, the equivalent expression specified by equation 3 herein is determined for the recursive equation 2.

At operation 1310, a trend component for the determined equivalent representation of the predicted value is determined. Details related to this operation are disclosed above regarding, for example, equations 4 and 5, as well as FIG. 9.

At operation 1315, decomposing the determined equivalent representation of the predicted value is decomposed into a trend component and a cyclic component. Detailed aspects of this particular operation are disclosed hereinabove with respect to FIGS. 10-12 and equations 6-8.

Operation 1320 of process 1300 includes, in some aspects, a practical application including the generation of a visualization for a set of time series data expressed by the decomposition determined at operation 1315. The generation of the visualization based on the decomposition and other determinations of process 1300 provides a novel representation of time series data built on a differencing technique that provides insight into time series data that is, in some aspects, easily understood.

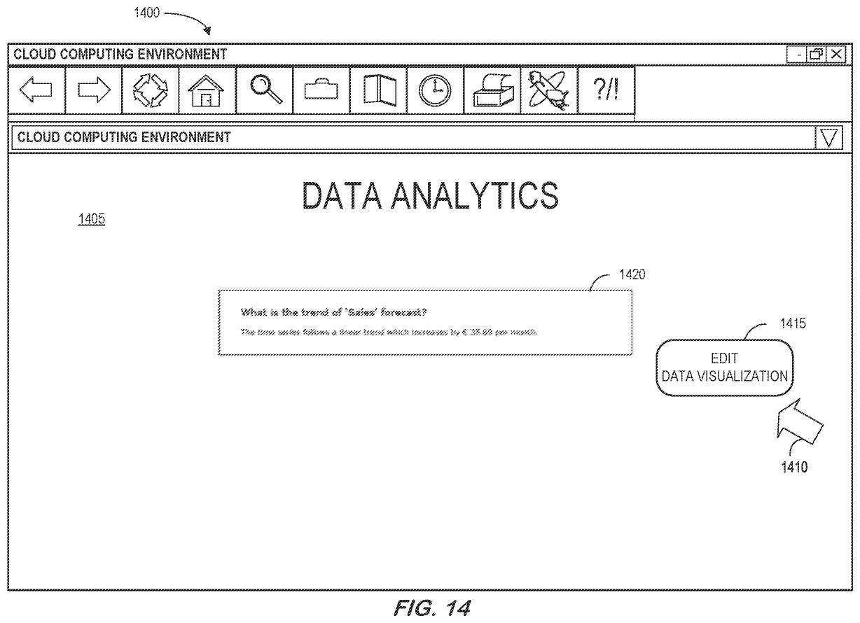

FIG. 14 is an outward-facing user interface related to a system and process for the determination of a visualization of predicted values for time series data based on a differencing technique, according to some embodiments. FIG. 14 is a human-machine interface display 1400 in accordance with some embodiments. The display 1400 includes a user interface 1405 that may be used to select or specify one or more data visualizations of time series data processed by a data analytics tool, system, or service. In particular, selection of an element (e.g., a database table or a specific portion thereof via a touchscreen or computer mouse pointer 1410) might result in the display including a presentation of a visualization or report based on the selected data entities. Display 1400 may also include a user selectable “Edit Data visualization” icon 1415 to request a new, revised, or updated visualization based on, for example, an updated selection or specification of data entities (e.g., to generate new dashboards or reports). In some aspects, display 1400 includes a semantic description 1420 explaining one or more aspects of predicted data determined according to a process herein.

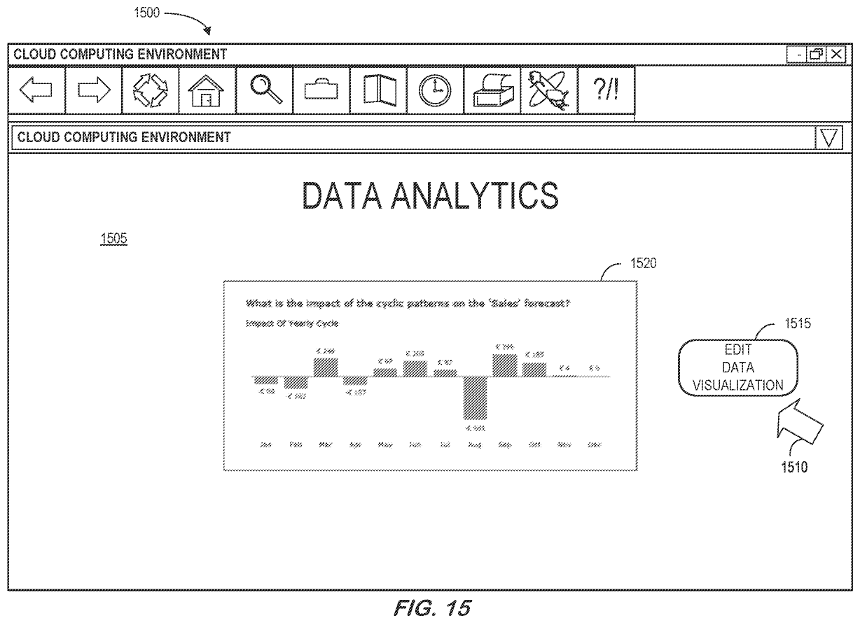

FIG. 15 is an outward-facing user interface related to a system and process for the determination of a visualization of predicted values for time series data based on a differencing technique, according to some embodiments. FIG. 15 is a representation of a human-machine interface display 1500 in accordance with some embodiments. Display 1500 includes a user interface 1505 that might be used to select or specify one or more data visualizations of time series data processed by a data analytics tool, system, or service. A selection of an element might result in the display of a presentation of a visualization or report based on the selected data entities. Display 1500 may also include a user selectable “Edit Data visualization” icon 1515 to request a new, revised, or updated visualization based on, for example, an updated selection or specification of data entities (e.g., to generate new dashboards or reports). In some aspects, display 1500 includes a graphical representation 1520 that operates to explain one or more aspects of predicted data determined according to a process herein.

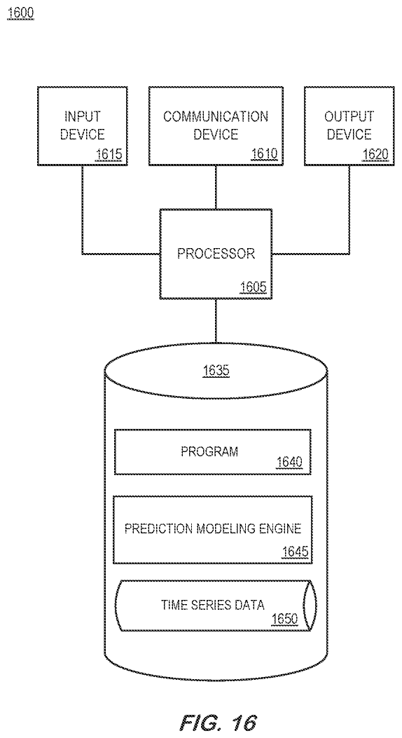

FIG. 16 is an illustrative block diagram of an apparatus or platform, in accordance with an example embodiment. Note that the embodiments described herein may be implemented using any number of different hardware configurations. For example, FIG. 16 is a block diagram of an apparatus or platform 1600 that may be, for example, associated with an implementation of processes disclosed herein (e.g., process 1300). Platform 1600 comprises a processor 1605, such as one or more commercially available CPUs in the form of one-chip microprocessors, coupled to a communication device 1610 configured to communicate via a communication network (not shown in FIG. 16). Communication device 1610 may be used to communicate, for example, with one or more remote applications or platforms. Apparatus 1600 further includes an input device 1615 (e.g., a computer mouse, a keyboard, etc.) and an output device 1620 (e.g., a computer monitor to render a visualization, create reports, etc.). According to some embodiments, a mobile device, PC, and other devices may be used to exchange data with apparatus 1600.

Processor 1605 also communicates with a storage device 1635. Storage device 1635 can be implemented as a single database or the different components of storage device 1635 can be distributed using multiple databases (that is, different deployment data storage options are possible). Storage device 1635 may comprise any appropriate data storage device, including combinations of magnetic storage devices (e.g., a hard disk drive), optical storage devices, mobile telephones, and semiconductor memory devices to support and facilitate a data plane as disclosed herein. Storage device 1635 stores a program 1640 and prediction modeling engine 1645 for controlling the processor 1605. Processor 1605 performs instructions of the programs 1640, 1645, and thereby operates in accordance with any of the embodiments described herein. Storage device 1635 further stores time series data 1650.

Programs 1640, 1645 may be stored in a compressed, uncompiled, encrypted, and other configured format. Programs 1640, 1645 may furthermore include other program elements, such as an operating system, clipboard application, a database management system, and device drivers used by processor 1605 to interface with peripheral devices.

As used herein, data may be “received” by or “transmitted” to, for example: (i) the platform 1600 from another device; or (ii) a software application or module within the platform 1600 from another software application, module, or any other source.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and any other non-transitory transmitting or receiving medium such as the Internet, cloud storage, the Internet of Things (IoT), or other communication network or link. The article of manufacture containing the computer code may be made and used by executing the code directly from one medium, by copying the code from one medium to another medium, or by transmitting the code over a network.

The computer programs (also referred to as programs, software, software applications, “apps”, or code) may include, for example, machine instructions for a programmable processor, and may be implemented in a high-level procedural, object-oriented programming language, assembly/machine language, etc. As used herein, the terms “machine-readable medium” and “computer-readable medium” refer to any computer program product, apparatus, cloud storage, Internet of Things, and device (e.g., magnetic discs, optical disks, memory, programmable logic devices (PLDs)) used to provide machine instructions and data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method, the method comprising:
determining, for a calculation of a predicted value specified by a recursive equation, an equivalent representation based on a cumulative sum;
determining a trend component for the determined equivalent representation of the predicted value;
decomposing the determined equivalent representation of the predicted value into the trend component and a cyclic component; and
generating a visualization for a set of time series data expressed by the decomposition.

2. The method of claim 1, wherein the cumulative sum starts from a first predicted data point.

3. The method of claim 1, wherein the trend component has a constant amplitude over time.

4. The method of claim 1, wherein a slope for the trend component is one of a constant, strictly increasing value, and a strictly decreasing value.

5. The method of claim 1, wherein the trend component and the cyclic component are expressed in a same value space.

6. The method of claim 5, wherein the value space for the trend component and the cyclic component is the same for the set of time series data.

7. The method of claim 1, wherein the generated visualization includes an indication of the determined trend component represented as at least one of a semantic description and a graphical representation.

8. A system comprising:
a memory storing processor-executable program code; and
a processor to execute the processor-executable program code in order to cause the system to:
determine, for a calculation of a predicted value specified by a recursive equation, an equivalent representation based on a cumulative sum;
determine a trend component for the determined equivalent representation of the predicted value;
decompose the determined equivalent representation of the predicted value into the trend component and a cyclic component; and
generate a visualization for a set of time series data expressed by the decomposition.

9. The system of claim 8, wherein the cumulative sum starts from a first predicted data point.

10. The system of claim 8, wherein the trend component has a constant amplitude over time.

11. The system of claim 8, wherein a slope for the trend component is one of a constant, strictly increasing value, and a strictly decreasing value.

12. The system of claim 8, wherein the trend component and the cyclic component are expressed in a same value space.

13. The system of claim 8, wherein the generated visualization includes an indication of the determined trend component represented as at least one of a semantic description and a graphical representation.

14. A non-transitory, computer readable medium storing instructions, which when executed by at least one processor cause a computer to perform a method comprising:
determining, for a calculation of a predicted value specified by a recursive equation, an equivalent representation based on a cumulative sum;
determining a trend component for the determined equivalent representation of the predicted value;
decomposing the determined equivalent representation of the predicted value into the trend component and a cyclic component; and
generating a visualization for a set of time series data expressed by the decomposition.

15. The medium of claim 14, wherein the cumulative sum starts from a first predicted data point.

16. The medium of claim 14, wherein the trend component has a constant amplitude over time.

17. The medium of claim 14, wherein a slope for the trend component is one of a constant, strictly increasing value, and a strictly decreasing value.

18. The medium of claim 14, wherein the trend component and the cyclic component are expressed in a same value space.

19. The medium of claim 18, wherein the value space for the trend component and the cyclic component is the same for the set of time series data.

20. The medium of claim 14, wherein the generated visualization includes an indication of the determined trend component represented as at least one of a semantic description and a graphical representation.
